(19) United States
(12) Patent Application Publication
(10) Pub. No.: US 2026/0367223 A1
(43) Pub. Date: Nov. 19, 2026

(54) MINIMIZING RADAR TRANSMISSION LOSS WITH RADAR CORRECTING LAYERS

(71) Applicant: PPG Industries Ohio, Inc., Cleveland, OH (US)

(72) Inventors: Eldon Lorenzo Decker, Gibsonia, PA (US); David Joseph Fortman, Pittsburgh, PA (US); Scott Joseph Moravek, Mars, PA (US); Sachit Goyal, Pittsburgh, PA (US)

(73) Assignee: PPG Industries Ohio, Inc., Cleveland, OH (US)

(21) Appl. No.: 19/155,639

(22) PCT Filed: Feb. 13, 2024
(86) PCT No.: PCT/US2024/015451

§ 371 Date: Aug. 12, 2025

Related U.S. Application Data
(60) Provisional application No. 63/485,235, filed on Feb. 15, 2023.
(60) Provisional application No. 63/605,484, filed on Dec. 2, 2023.

(51) Int. Cl. G01S 7/40; G01S 7/02; G01S 7/03; G01S 13/931; H01Q 1/42

(52) U.S. Cl. CPC G01S 7/4039; G01S 7/027; G01S 7/03; G01S 13/931; H01Q 1/422; G01S 2013/93271

(57) ABSTRACT

A computer-implemented method of making a color match to be radar compliant can include identifying and displaying a set of candidate colors from a database that match a color of a vehicle, and receiving a user selection thereof. The method can also include generating a formulation of the selected candidate color that is applied to the vehicle, and receiving a radar measurement of radar transmission loss over a section where there is a radar transceiver within the vehicle. In addition, the method includes iteratively applying a radar correction layer, as may be needed, at the location of the radar transceiver, and determining whether a combined set of layers comprising the radar correction layer, the section of the vehicle, and the applied formulation meets the radar compliance requirement. The method can further comprise displaying the results thereof.

### BACKGROUND OF THE DISCLOSURE

### 1. Technical Field

The present disclosure relates to systems, computer-implemented methods, and storage media for using a radar correcting layer with a coating to comply with a radar compliance requirement.

### 2. Background and Relevant Art

Modern vehicles have been developed to assist drivers in diverse ways. For example, advanced driver assistance systems (ADAS), are those equipped with many sensors including radio detection and ranging (radar) sensors, light detection and ranging (LiDAR) sensors, optical sensors (e.g., cameras), ultrasound sensors, and the likes. These sensors are located outside of vehicles or hidden in the body of the vehicles to identify obstacles, pedestrians, other vehicles, weather, etc. so as to warn drivers about upcoming dangerous situations and to make a sudden stop to prevent potential contacts with the identified objects. ADAS may combine data from various sensors to identify objects and to decide whether to provide automatic emergency assistance for drivers.

When vehicles with ADAS need to be refinished (in the case of damage) or repainted for any reason, color matches tend to emphasize color without regard for whether the ADAS will be impaired, or tend to sacrifice color match for sensor function compliance. In particular, the new coating layer might have adverse effects on or decrease functionalities of the sensors. This can have adverse effects on the safety features, among other things, of a vehicle.

### BRIEF SUMMARY

The present disclosure provides systems, methods, and computer program products for providing for using a radar correcting layer to enable a coating that may otherwise not be radar compliant to meet radar compliance requirements.

For example, a computer-implemented method of minimizing radar loss by virtue of an applied coating may include: iteratively applying one or more radar correcting layers to a vehicle, for which a coating has been applied over a section to which a radar transceiver radiates an electromagnetic wave, wherein the coating and vehicle section, in combination, do not comply with a radar compliance requirement. The computer-implemented method may also include selecting a radar correcting layer of the one or more radar correcting layers that, when the selected radar correcting layer is applied over the section, changes a measured radar transmission loss through the section, such that the coating and the selected radar correcting layer combine with the section of the vehicle to comply with the radar compliance requirement.

In addition, a computer-implemented method of minimizing radar loss by virtue of an applied coating may include receiving a vehicle, for which a coating has been applied over a section to which a radar transceiver radiates an electromagnetic wave, wherein the coated section does not comply with a radar compliance requirement. The computer-implemented method may also include iteratively applying a plurality of radar correcting layers to the vehicle over the coated section; and selecting an applied radar correcting layer when the applied radar correcting layer changes a measured radar transmission loss through the coated section, such that the coating and radar correcting layer combine with the coated section of the vehicle to comply with the radar compliance requirement.

Furthermore, a system of the present disclosure may include a memory, a processor, and one or more non-transitory computer readable medium including one or more programs so stored thereon that, when executed by a computer, cause the computer to identify a set of candidate colors from a database to match a color of a vehicle, and displaying the set of candidate colors. The system can also be configured to receive a user selection from a digital device of a candidate color from the set. In addition, the system can be configured to generate a formulation of the selected candidate color that is applied to the vehicle, and receive a radar measurement pertaining to radar transmission loss due to the applied formulation, wherein the radar transmission loss is compared against a radar compliance requirement. In one example, if the radar transmission loss meets or exceeds the radar compliance requirement, the system can then display a result of the comparison, or (ii) if the radar transmission loss does not meet the radar compliance requirement, the system can receive a new measurement that represents a radar loss signal taken from a section of the vehicle where a radar correction layer has been applied, the section comprising the radar correcting layer at a location on the vehicle to which a radar transceiver radiates an electromagnetic wave. Furthermore, the system can determine whether a combined set of layers comprising the radar correction layer, the section of the vehicle, and the applied formulation meets the radar compliance requirement; and display a result of the determination.

Still further, an additional or alternative method of minimizing radar loss by virtue of an applied coating can include iteratively applying, by a user, one or more radar correcting layer to a section of a vehicle, for which a coating has been applied over the section, and to which a radar transceiver radiates an electromagnetic wave, wherein the combination of applied coating and section of the vehicle, does not comply with a radar compliance requirement. The method can also include, after application of each iteratively applied radar correcting layer determining whether the applied radar correcting layers change a measured radar transmission loss through the section, such that the coating, and the selected radar correcting layers combine with the section of the vehicle to comply with the radar compliance requirement.

Yet still further, an additional or alternative method of minimizing radar loss by virtue of an applied coating can include determining that a vehicle section and an applied coating do not meet a radar compliance requirement when transmitting an electromagnetic wave through the vehicle section. Thet method can also include applying an initial radar correcting layer to the vehicle section; and determining that a measured radar transmission loss changes when the initial radar correcting layer is applied over the section.

The above-mentioned methods and may also be applied in terms of systems and storage media with program code thereon for implementing the same.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims, or may be learned by the practice of the examples as set forth hereinafter.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, the present disclosure will be described and explained with additional specificity and detail through the use of the accompanying drawings in which:

FIG. 1A shows a graphical illustration in which a user analyzes a damaged vehicle at a body shop, in accordance with the present disclosure;

FIG. 1B shows a graphical illustration in which a user applies a correcting layer for a sensor to a vehicle after repairing damages and applying a new coating to the vehicle at a body shop, in accordance with the present disclosure;

FIG. 2A shows a schematic in which a correcting layer is applied as a back layer of a body of a vehicle, in accordance with the present disclosure;

FIG. 2B shows a schematic in which a correcting layer is applied as a front layer of a body of a vehicle, in accordance with the present disclosure;

FIG. 2C shows a schematic in which multiple correcting layers are applied as a back layer of a body of a vehicle, in accordance with the present disclosure;

FIG. 2D shows a schematic in which a correcting layer is applied to a back side/inner surface of a body of a vehicle section, with another correcting layer applied on an opposing side of the vehicle section, in accordance with the present disclosure;

FIG. 3A illustrates a schematic of a system for making a new coating to meet a compliance requirement, in accordance with the present disclosure;

FIG. 3B illustrates a schematic of a system for making a new coating to meet a compliance requirement, in accordance with the present disclosure;

FIG. 4 illustrates a flowchart of a method in accordance with the present disclosure for providing a workflow at a body shop to make a new coating to meet a radar compliance requirement;

FIG. 5 illustrates a flowchart of an additional or alternative method in accordance with the present disclosure for providing a workflow at a body shop to make a new coating to meet a radar compliance requirement; and

FIG. 6 illustrates a further flowchart of an additional or alternative method in accordance with the present disclosure for providing a workflow at a body shop to make a new coating to meet a radar compliance requirement.

### DETAILED DESCRIPTION

The present disclosure provides systems, methods, and computer program products for providing for using a radar correcting layer to enable a coating that may otherwise not be radar compliant to meet radar compliance requirements.

As a preliminary matter, the definite articles “a” or “an” as used herein will be understood to mean “at least one” or “one or more” wherever occurring, unless expressly defined to mean only the singular form. In addition, by way of further explanation, the terms “module” or “component,” when used in the context of a computer system, computer-implemented methods, or corresponding structure and functions, will be understood as abstractions of generalized computer processing components that can be used in at least one implementation of the present invention, and there may be more or fewer than those illustrated and described, and as may be suited for a particular server and cloud operating environment. As used herein, a “module” means computer executable code that, when executed by one or more processors at a given computer system, causes the given computer system to perform a particular function. By contrast, a “component” means a passive set of instructions or data structures or records that can store, manage, and/or otherwise provide information handled through a given module. One of skill in the art, however, will appreciate that the distinction between different modules or components is at least in part arbitrary, and that modules or components may be otherwise combined and divided and still remain within the scope of the present disclosure. As such, the description of a component as being a “module” or a “component” is provided only for the sake of clarity and explanation and should not be interpreted to indicate that any particular structure of computer executable code and/or computer hardware is required, unless expressly stated otherwise. In this description, the terms “component,” “agent,” “manager,” “service,” “engine,” “virtual machine” or the like may also similarly be used.

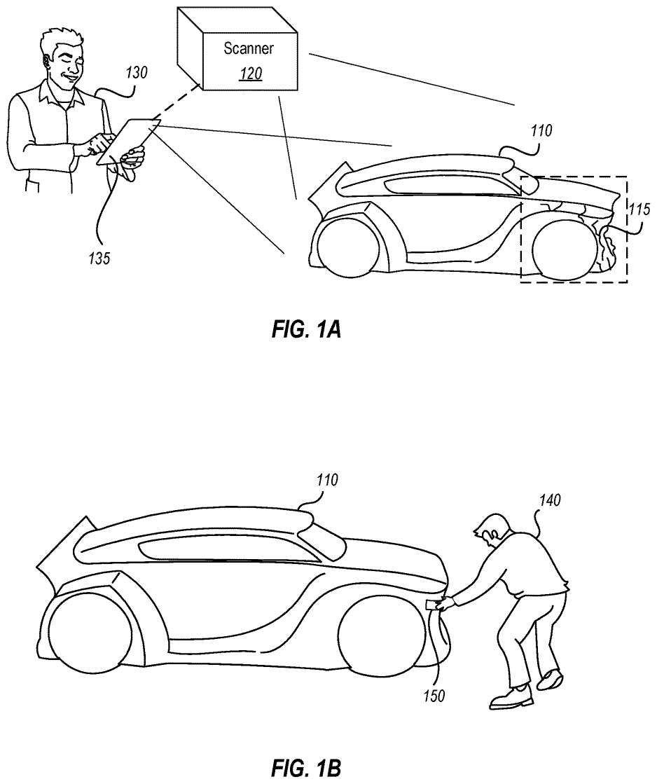

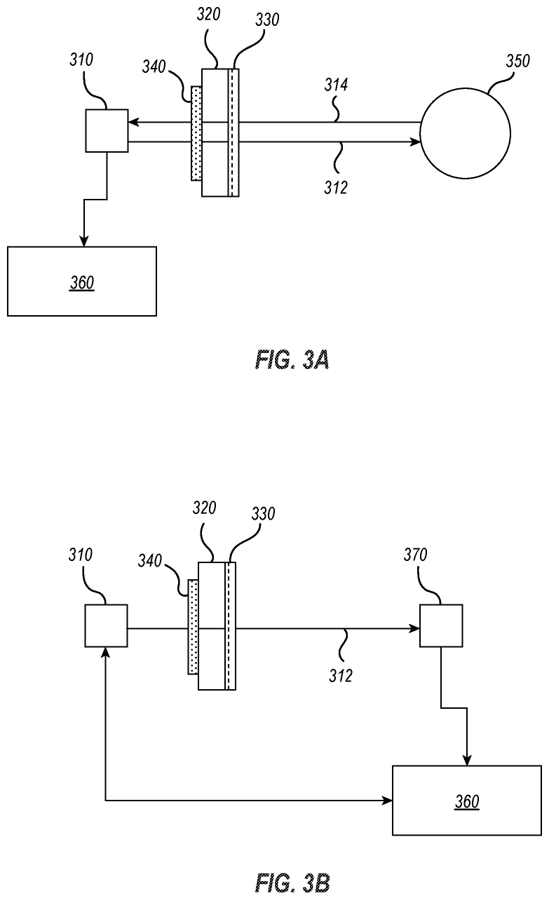

Referring now to the Figures, when a vehicle needs to be repainted, or needs to be refinished for any reason, an end user 130 at, for example, a body shop, will need to undertake several different steps to ensure not only that the coating is appropriately matched to the original, but also that the radar equipment (e.g., ADAS equipment, including radar transceivers) can operate as originally intended despite the new coatings. In this regard, FIG. 1 illustrates an engineer/manager/mechanic 130 (hereinafter “end-user”) with a vehicle 110 at the body shop. The end-user 130 may manually inspect the vehicle 110 by looking at one or more damaged sections 115 (individually a “damaged section 115”), and interact with a digital device 135 (also 360, FIGS. 3A-3B), which may be a portable laptop, mobile phone, tablet computer, or other portable digital device.

To identify a replacement coating, the end-user 130 may input values into a database, such as vehicle identification numbers (VIN), make/model/year, manufacturer paint code, etc. or may use a colorimeter or spectrophotometer (e.g., scanner 120) to identify the original color pursuant to preparing a closest match alternative coating. In general, paint manufacturers develop a large range of coatings with different colors, color variations, color effects, and the like, whether for the original automotive companies, or independently, such as to refinish parts of the vehicle 110 painted with coatings from another manufacturer. The sheer volume and range of colors and coatings developed by paint manufacturers frequently provides a suitable overall color match with the damaged sections 115 where basic color comparison on a display screen is the only consideration. Close inspection after application, however, frequently reveals small deviations in the colors that may not be apparent to the repair operator (e.g., auto-body operator), relevant front office manager, or the parts manager when looking at a color chip or computer display screen during the coating determination process.

For example, there may be differences owing to the color or physical characteristics of the underbody coating, or other effect pigments. Along these lines, flake, metallic, or other gonio-apparent pigments added to the formulation can provide a mixed coating with a completely different overall color effect under certain lighting conditions than the same coating composition without the effect pigment.

Further, the color of the damaged vehicle 110 may be shown differently based on at least temperature, a level of moisture, and/or a level of illumination at the body shop. Under these circumstances, a scanner 120 may be used to scan the color of the damaged vehicle 110 and look for candidate colors. The scanner 120 may be a spectrophotometric measurement device. Based on the scanned data and a vehicle color database, the end-user 130 may be provided with a list of potential candidate colors. Alternatively, potential candidate colors may be selected based on a vehicle identification number (VIN), a make/model, or manufacturer paint code. In either case, as shown in FIG. 1A, the end-user 130 uses the portable digital device 135 to review a list of potential candidate colors. The selected coating may comprise a color match, but may be listed as radar non-compliant, meaning that the coating has not been optimized for radar transmission. For example, the candidate coating may include a set of pigments, such as for instance electrically conductive pigments, such as for instance metal flake pigments, that cause the coating to be less transparent to radar transmission. On the other hand, the digital device 135 may provide a candidate color that is not a perfect match, but is radar compliant, meaning that it is formulated to minimize radar transmission loss.

Should the best color match be a coating that is not formulated to minimize radar transmission loss, the present disclosure provides several remedies at the disposal of the end user 130. For example, based on the user's selection, a formulation of the selected color may be generated and applied to the repaired portions at the damaged section 115 of the vehicle 110. For example, FIG. 1B shows vehicle 110 after repair, at which point the end-user 130 may apply a coating, whether manually or through one or more automated systems.

The generated formulation is applied to the repaired portions of the vehicle 110. The applied formulation may include a base coat and a clear coat. As used herein, the terms “on,” “applied over,” “applied on,” “formed over,” “formed on, “deposited over,” “deposited on,” “overlay,” “provided over,” “provided on,” and the like, mean formed, overlaid, deposited, or provided on but not necessarily in contact with the surface. For example, a formed layer “applied over” a substrate layer does not preclude the presence of one or more other layers of the same or different composition located between the formed layer and the substrate layer.

Herein the term “coating” or “coating layer” may refer to a single coating layer, or it may refer to multiple coating layers deposited upon one another on a section of the vehicle, such as for instance, an adhesion promoter deposited onto a section of the vehicle, followed by a sealer or a primer deposited thereon, followed by one or more layers of base coat deposited thereon, followed by a clearcoat deposited thereon. Other variations of this coating layer stack are possible, such as, for instance the absence of any of said layers, or the addition of multiple of any of said layers. Each said coating layer may have its own relative electric permittivity and thickness, and each said layer may contribute to varying amounts to the final measured radar transmission loss for a coated section of the vehicle where a radar transceiver is positioned.

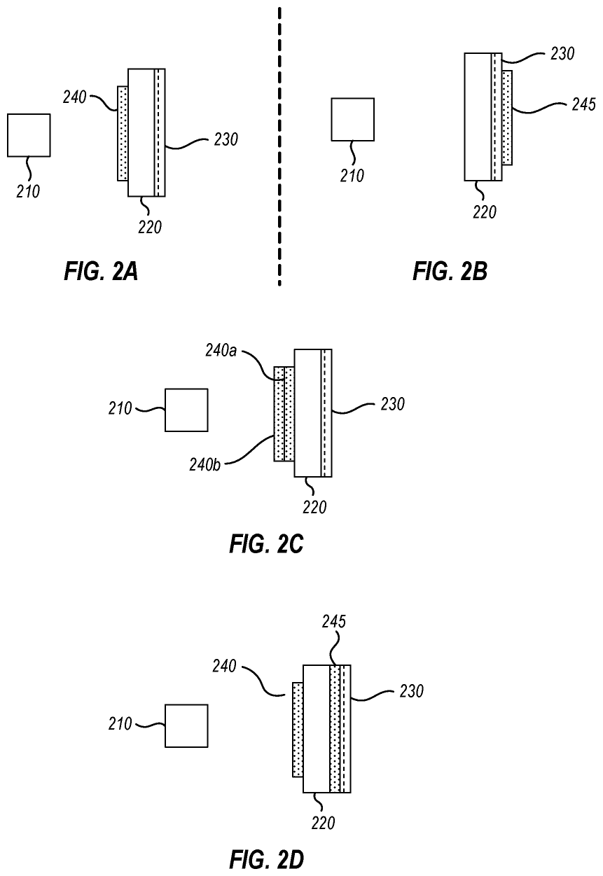

After application of the formulation or a color coating of the selected color, the end-user 130 will monitor each location of the vehicle where a radar transceiver (element 210, FIGS. 2A-2C) is present. Specifically, the end-user 130 will measure the amount of radar transmission loss that has occurred with the new coating over that particular vehicle section (i.e., the section where the radar transceiver is positioned and a new coating is applied) to determine the impact of the radar transmission loss due to the repair.

When the new coating decreases the performance of one sensor, end-user 130 may apply a radar correcting layer 150 to a section where the sensor is positioned, as illustrated in FIG. 1B. Specifically, the end-user 130 temporarily applies the radar correcting layer 150 to a section of the body of the vehicle 110, to which the sensor radiates signals and from which the sensor receives signals reflected from objects outside of the vehicle 110. The radar correcting layer 150 may be a film or a wrap (of a particular size, permittivity, and/or thickness) applied to an outer surface of the vehicle section, but may alternatively be applied between the radar transceiver and an inside surface of the vehicle section—i.e., a “backer layer.” Alternatively, the radar correcting layer 150 may comprise a film that covers the entire section of the vehicle.

The radar correcting layer 150 can be a coating, a film, a wrap, or a combination thereof. For example, the radar correcting layer 150 can be a coating and can be in direct contact with a surface of the vehicle 110, while the opposing surface of the vehicle 110 bears the applied coating. As used herein, a “coating” is a surface covering, such as, for example, a paint for at least a portion of an object that can be applied in, for instance, liquid, paste, slurry, or powder form, which upon drying and/or curing, forms a self-supporting continuous film over a least a portion of the object. A film is a surface covering for a least a portion of an object that is applied as a solid and pliable layer, which can be a self-supporting thermoplastic film or is at least partially cured and/or dried prior to application to at least a portion of the object.

The film can be a multilayer film comprising at least two layers, including a first film layer comprising a thermoset or thermoplastic layer and an optional adhesive layer, such as a pressure sensitive adhesive. The adhesive layer can be protected with a removable layer or release liner that would be removed prior to application of the film to a substrate. The adhesive layer may allow the film to temporarily or permanently adhere to the desired surface. The first film layer may be applied over at least a portion of a carrier film that would support the first film layer until the first film layer is formed, and thereafter the carrier film may optionally be removed. The first film layer may be applied over at least a portion of a protective clear film that itself may be on a carrier film.

The protective clear film may be thermoset or thermoplastic and would be the top layer when the multilayer film is applied over at least a portion of the vehicle 110 via contact of the adhesive layer with the vehicle 110. The radar correcting layer 150 may be hidden from the view of the relevant operator or other person when the vehicle 110 is in use.

A layer of the multilayer film may comprise thermoset or thermoplastic polyurethane, thermoplastic polyolefin, or any other appropriate film forming material known in the art. In some cases, the film composition will additionally comprise fillers or pigments as described below. The first film layer of the film may be spray applied, extruded, formed, laminated, or polymerized in situ, or otherwise deposited to an adjacent layer of a multilayer film or to a removable layer. In some cases, the film layer may comprise at least three layers, comprising a clearcoat layer, a thermoset or thermoplastic layer, and an adhesive layer.

The radar correcting layer 150 can comprise a film-forming resin and optionally a filler, such as, for example, talc, calcium carbonate, clays, silica, sulfate or sulfite minerals (e.g. barium sulfate), metal oxides (e.g., titanium dioxide, iron oxide, micaceous iron oxide, aluminum oxide, zinc oxide), titanate compounds (e.g., barium titanate, calcium copper titanate, sodium titanate, strontium titanate), sulfide minerals (e.g. iron sulfide), metal flakes or powders (e.g. aluminum flakes), other ceramic powders (e.g. boride, carbide, or nitride compounds), carbon (e.g., radar transmissive carbons), silicon, germanium, hydrogenated amorphous-silicon, glass flakes or spheres, other pigments, a fibrous material, or a combination thereof. Use of any of the listed filler materials, or a combination thereof, can generally increase the permittivity of the radar correcting layer 150.

Stated another way, a manufacturer or technician may adjust permittivity of the backer layer upward or downward by adjusting the composition of the backer layer. Thus, the filler may be incorporated into the radar correcting layer 150 at an appropriate concentration to control the permittivity of the radar correcting layer 150 and allow for increased radar transmission through the radar transmissive section. For instance, the radar correcting layer may comprise a film-forming layer with a pigment volume concentration (PVC) of 0% to 90% of the filler in the solid layer, such as 1% to 50%, such as 5% to 30%, such as 10% to 20%.

The permittivity, ε′, (i.e., real permittivity) of the radar correcting layer 150 may be greater than 1, and may be, for example, at least 2 as measured with a radar measurement system such as, for example, an RMS-D from Perisens GmbH at a wavelength in range of 76 GHz to 81 GHz. The permittivity, ε′, of the radar correcting layer 150 may be no greater than 30, and may be, for example, no greater than 10, all as measured with an RMS-D from Perisens GmbH at a wavelength in range of 76 GHz to 81 GHz. For example, the permittivity, ε′, of the radar correcting layer 150 may be in a range of 1 to 30, and may be in the range of, for example, 1 to 30, or 1.5 to 10, as measured with an RMS-D from Perisens GmbH at a wavelength in range of 76 GHz to 81 GHz.

The radar correcting layer 150 can comprise an L₁₅ value of 115 or greater as measured using a multi-angle spectrophotometer on the substrate layer 220, such as, for example, 120 or greater, 125 or greater, 130 or greater, 140 or greater, 150 or greater, or 160 or greater, all as measured using a multi-angle spectrophotometer on the substrate layer 220. The radar correcting layer 150 may comprise an Lis value of less than 115 and may have limited if any metallic luster. The radar correcting layer 150 may comprise a color comprising a hue value of h=0° to 359° and a chroma value C*>50 or C*<50 as measured at a measurement angle from 15° to 110° using a multi-angle spectrophotometer. The radar correcting layer 150 can comprise a haze of no greater than 50% as measured according to ASTM D1003 or the radar correcting layer 150 can comprise a haze of at least 50% as measured according to ASTM D1003 based on the desired application. The radar correcting layer 150 can be visibly opaque.

Generally, electromagnetic waves are reflected, diffracted, and refracted at a boundary between two different mediums. Not intending to be bound by any particular theory, by applying the radar correcting layer 150, the electromagnetic waves radiated by a radar transceiver are likely reflected, diffracted, and refracted while passing through the radar correcting layer 150, the substrate (e.g., vehicle section), and the coating. Thereby, based on applications of various thicknesses of the radar correcting layer 150, one or more radar correcting layers 150 may minimize adverse effects from the components of the coating so that the sensor can properly perform its functions. The radar correcting layers 150 may also be applied in a stacked formation, or on alternate sides of the vehicle section (front and inside surfaces) as needed to minimize radar transmission loss.

In one example, the radar correcting layers 150 disclosed herein can be provided in different sets of one or more thicknesses all corresponding to one permittivity. For example, a manufacturer may provide a set of radar correcting layers at a first, second, third, and fourth thickness at one permittivity value “A” that is higher permittivity, and another set of radar correcting layers at a first, second, third, and fourth thickness at another permittivity value “B” that is a moderate permittivity. Similarly, the manufacturer may provide still another set (or more) of radar correcting layers at a first, second, third, and fourth thickness at yet another permittivity. The thicknesses can vary as needed, however, in one example, the thicknesses in each set comprise a 100 μm, a second at 200 μm, a third at 400 μm, and a fourth at 800 μm. In general, understanding the sinusoidal-like variation of the radar loss as a function of frequency due to interference effects for the electromagnetic radar waves interacting with the section of a vehicle ((e.g., 220, FIGS. 2A-2D)) with the applied coating (e.g., 230, FIGS. 2A-2D), the different levels of thickness in each set can be understood to cause different amounts of frequency shift in the position of a minimum in the sinusoidally-varying radar loss vs. frequency, to increase or decrease this minimum position, to correspond to the desired frequency range where the radar is desired to be minimized. For instance, one may desire to minimize the loss between 76-81 GHz, or between 76-77 GHz, or between 77-81 GHz. The shift in the frequency corresponding to the minimum radar loss, provided by the given thickness of any given radar correcting layer, can be understood as being adjusted with each further layer stacked on any other given layer.

For example, the end-user 130 may, in an attempt to minimize radar loss at 76.5 GHz, find that applying a 100 μm thick radar correcting layer to the backside of vehicle section 220 increases the radar transmission loss at 76.5 GHz. Whereas, adding a 100 μm and 200 μm radar correcting layer together may shift the sinusoidally-varying radar loss vs. frequency curve enough that the radar transmission loss is much lower at 76.5 GHZ than without the radar correcting layer. As understood more fully with respect to FIGS. 2A-2D, an end-user can apply a radar correcting layer in a variety of layouts/arrangements pursuant to minimizing radar transmission loss.

For example, FIGS. 2A-2D show different configuration of one or more radar correcting layers 150 (now referred to as 240 for an inside surface layer, or 245 for an outside surface layer) with respect to the new coating on the section to which a radar transceiver 210 radiates electromagnetic waves and from which the radar transceiver receives signals reflected from objects around the vehicle (e.g., 110). The sizes and thicknesses of the radar transceiver 210, a section 220, a coating 230, and a radar correcting layer 240 in FIGS. 2A-2D are not shown in scale to provide clear distinction therebetween. In particular, the thickness of the coating 230 and the radar correcting layer 240 are exaggerated compared to the thickness of the section 220 to be visible next to the section 220. FIGS. 2A-2C show an expanded view of the section where the radar correcting layer is applied. The location where a radar transceiver is located is behind the section 220 of the vehicle (e.g., behind a bumper fascia of the vehicle 110).

FIG. 2D shows yet another schematic in which a correcting layer is applied to a back side/inner surface of a body of a vehicle section, with another correcting layer applied on an opposing side of the vehicle section, in accordance with the present disclosure. For example, the end user 130 may identify that radar transmission loss may be minimized by selective application of both back and front-applied correcting layers. In the illustrated example, the front radar correcting layer 245 is applied to the vehicle section substrate 220 before application of the coating layer 230, and hence is between the vehicle substrate 220 and coating layer 230. In such a case, the front radar correcting layer 245 may comprise a film or other coating that is applied to the substrate 220 before application of the conventional coating layer 230. In still further examples, the end user 130 may apply multiple radar correcting layers 150 (i.e., 240/245) in various front or rear sides of the substrate 220 as needed.

Nevertheless, in more typical cases, the coating 230 is applied over the section 220 (e.g., a panel of a vehicle in front of a radar transceiver), particularly on the outer surface of newly coated portion of the vehicle. In consideration of the wavelength of the electromagnetic wave, the thickness and relative electric permittivity of the section 220 of the vehicle 110 and the coating layer 230 on the section of vehicle may be considered to calculate the radar transmission loss at each frequency generated by the radar transceiver 210. For example, the radar transceiver 210 generates and radiates an electromagnetic wave, of which frequencies vary, for example, from 24×10⁹ Hz (24 GHz) to 79 GHz, or for instance, a range of frequencies, such as 76-81 GHz. This range of frequencies may include higher frequencies and/or lower frequencies. When the frequency of the electromagnetic wave is 24 GHz or 79 GHz, the corresponding wavelength of the electromagnetic wave is 12.5 mm or 3.8 mm, respectively. It is known that when a layer interacting with an electromagnetic wave has a thickness on the order of the wavelength of the electromagnetic wave, then the wave interference effects can be significant, such that depending on the wavelength the electromagnetic wave amplitude can be increased or decreased to varying amounts. Thus, if a section of the vehicle has a thickness of about 1 mm to 4 mm, and this is of the same order of magnitude as the wavelength of radar signals of 76 to 81 GHz, 3.9 mm to 3.7 mm respectively, it is expected that there would be significant wave interference effects from a section of the vehicle.

Assuming that the thickness of the coating ranges from 1 μm to 100 μm, and that the thickness of the section of the vehicle is 1 to 4 mm, if the coating has nearly the same relative electric permittivity as the bumper, then the effect of the coating in the wave interference effects is less than the effect of the section of the bumper. However, if the relative electric permittivity of the coating is different, such as by a difference in relative electric permittivity of greater than 1, such as greater than 5, such as greater than 10, or greater than 50, then the combined wave interference effects of the section of the vehicle and the coating can be significant and lead to greater or less radar transmission loss than in the absence of the coating, depending on the frequency of the electromagnetic wave.

Likewise, depending on the thickness and permittivity of the radar correcting layer 240, said radar correcting layer can have an impact on the wave interference effects, as previously noted. When combined with the wave interference contributions from the section of the vehicle and the coating, this may affect an increase or a decrease in the radar transmission loss. Thus, ideally one would calculate the radar transmission loss due to any configuration of radar correcting layer and coating applied to a section of a vehicle, if the values of relative electric permittivity and thickness for each are known. And if the thicknesses and relative electric permittivity values of the section of vehicle, the coating, and the radar correcting layer were known, then the radar transmission loss, could be minimized by adjusting the thickness and permittivity of the radar correcting layer. However, in practice, these thickness values are typically not known with sufficient accuracy to enable such a predictive optimization process.

Therefore, in practice, it may be feasible to iteratively apply various radar correcting layers of different permittivity and/or thickness values, until an acceptable amount of radar transmission loss is achieved from the combination of radar correcting layer, section of the vehicle, and the coating. In the absence of precise values of relative electric permittivity and thickness for the section of the vehicle and the coating, but with known measured radar transmission loss over a range of frequencies, it may be possible to model this scenario and predict the proper radar correcting layer (with a value of relative electric permittivity and thickness) that would enable the combination of the radar correcting layer, the section of vehicle, and the coatings to be in compliance with a radar loss transmission specification at a specific radar frequency or over a specific radar frequency range.

With regard to location, in FIG. 2A the radar correcting layer 240 (i.e., a backer layer) is applied to the back of the section 220 (i.e., the inside surface) so that the electromagnetic wave passes through the radar correcting layer 240, the section 220, and the coating 230 (i.e., positioned on the outside surface of the vehicle section 220) in order. Since the radar correcting layer 240 is applied to the back/inside of the section 220, any calculation of radar transmission loss for this combination of backer layer, section 220 and coating 230 would need to account for this specific order of position relative to the transceiver 210. However, if simply iteratively applying different radar correction layers, the order and positioning is irrelevant, as only the goal of reducing the measured radar transmission loss using a radar correction layer would matter.

Alternatively, in FIG. 2B, the radar correcting layer 245 (i.e., a front layer) is applied to the front/outside of the section 220 so that the electromagnetic wave passes through the section 220, the coating 230, and the radar correcting layer 245 in order. (The radar correcting layer 245 may be alternatively positioned between the outer surface of section 220 but inside the coating layer 230, such as in FIG. 2D). The front-oriented radar correcting layer 245 may be the same or different from the radar correcting layer 240 in thickness and/or compositions. Since the radar correcting layer 245 is applied to the front of the section 220, any calculation of radar transmission loss for this combination of front layer, section 220 and coating 230 would need to account for this specific order of position relative to the transceiver 210. However, if simply iteratively applying different radar correction layers, the order and positioning is not as relevant as the end-result based on the measured radar transmission loss using a radar correction layer.

As previously noted, there may be a case where one radar correcting layer 240/245 is not sufficient to minimize the radar transmission loss through the coating 230. In such a case, an additional one or more radar correcting layers can be applied to the section 220. For example, as illustrated in FIGS. 2C and 2D, one or more radar correcting layers 240a, 240b are applied to the rear section 220, with FIG. 2D differing by adding another front layer 245 between substrate 220 and coating 230. The added correcting layers 240/245 thus vary the overall thickness of the combination stack, meaning the combination of the vehicle section 220 thickness as combined with the given thicknesses of each correcting layer 240(a/b)/245 and the thickness of coating 230.

In other words, as shown in FIGS. 2C-2D, one or more radar correcting layers 240a, 240b may be applied to the back of the section 220 and/or to the front of the section 220 and the coating 230 in order to vary the thickness through which the radar signal will travel. According to the present disclosure, one or more radar correcting layers may be applied to both the front and the back of the section 220. Based on the combination of the radar correcting layers applied to the front and the back of the section 220, radar transmission loss may be minimized in both directions of transmission of the electromagnetic wave and reception of the reflected signal.

For purposes of this discussion, the radar correcting layer 150 is used to individually or collectively represent all radar correcting layers 150 (e.g., 240, 245), as shown in FIGS. 2A-2D. According to the present disclosure, each radar correcting layer 150 (i.e., 240, 245) may be the same as each other in thickness and/or compositions. Alternatively, each radar correcting layer 150 (i.e., 240, 245) may be different from each other in thickness and/or compositions. For example, under certain situations, a thicker radar correcting layer may serve better than a thinner radar correcting layer, or vice versa. In other cases, multiple radar correcting layers 150 (i.e., 240, and/or 245) may be stacked to achieve various optimizations, as noted above. Thus, under various conditions, a combination of different thickness-radar correcting layers may be applied in various orderings.

A threshold for the radar transmission loss can be determined based on a radar compliance requirement. In a case when the effects of the coating 230 on the electromagnetic wave transmission and reception is less than the threshold, the coating 230 is identified as radar compliant. In such a case, no application of the radar correcting layer 240 is needed. However, when the coating 230 is not radar compliant according to a given standard, one or more radar correcting layers 240 may be iteratively applied to make it radar complaint. When the radar compliance requirement is met after application of one radar correcting layer 240, the combination of the coating 230 and the radar correcting layer 240 is identified as radar compliant. Otherwise, the combination of the coating 230 and the radar correcting layer 240 is identified as radar non-compliant or as not meeting the radar compliance requirement. In such a case, one or more radar correcting layers 240 may have to be iteratively applied until the given radar compliance requirement is met.

According to the present disclosure, when one radar correcting layer 240 does not make the coating 230 radar compliant, another radar correcting layer 240 may be applied by replacing the previously applied radar correcting layer 240, such that only one radar correcting layer 150 (whether 240 or 245) is present with the coating 230. Alternatively, another radar correcting layer 240 may be applied to the previously applied radar correcting layer 240 (i.e., FIG. 2C, elements 240a, 240b), thereby increasing the thickness of the overall radar correcting layers. Both replacement and additional application of one or more radar correcting layers 150 may be used at any point in time to make the coating 230 radar compliant.

In the present disclosure, a radar transmission loss is a positive value, such that if the radar transmission loss equals 0 dB, there is no loss, and if the radar transmission loss value is greater than 0 dB then the radar signal from a radar transceiver has been reduced. Thus, for example, for one-way-transmission measurement of a radar wave through a coated section of a vehicle, if the radar transmission loss has a value of 5 dB, that is more radar transmission loss than if the one way radar loss has a value of 3 dB, or 2 dB, or 1 dB.

A radar transmission loss specification may indicate the maximum value of one-way or two-way radar transmission loss at a given frequency in order to be radar compliant. For example, a radar loss specification may be: one-way radar transmission loss <2 dB at 79 GHz. Another could be: one-way radar transmission loss <1.5 dB at 76.5 GHz. Still another could be: two-way radar transmission loss <3.5 dB at 77 GHz.

In this regard, measurements of the radar transmission loss are used to check whether the radar compliance requirement has been met. In a case where the coating does not meet the radar compliance requirement, FIGS. 3A and 3B illustrate how the radar transmission loss due to the coating 330 is measured in the presence of a radar correcting layer with respect to the electromagnetic wave. The radar correcting layer 340 (in this case an inner surface applied layer/backer layer) can be applied to the back/inside surface of the section 320 as illustrated in FIGS. 3A and 3B. However, the location for the radar correcting layer 340 is not limited to the back of the section 320 but may be the front/outer surface of the section 320 or both.

A computing device 360 (or 135) may be connected to a radar transceiver 310 so that the computing device 360 receives measurements from the radar transceiver 310. The computing device 360 may comprise an application or virtual machine, or may be an application installed on a separate, stand-alone computing system, such as a local or remote computer system connected to the radar transceiver 310 over a local or global network. In particular, the network may be a global, wide, or local area network, including the Internet. The data communication between the radar transceiver 310 and the computing device 360 may utilize NFC, Bluetooth, or other suitable wireless communication protocols.

The computing devices described herein (e.g., 135, 360) may comprise a number of modules, components, and databases that assist in determining whether the combination of the radar correcting layer 340 and the coating 330 meets the radar compliance requirement.

In FIG. 3A, a predetermined object 350 is placed at a predesigned distance from the radar transceiver 310. The shape of the predetermined object 350 may have any shape easily detectable by the radar transceiver 310. The radar transceiver 310 radiates an electromagnetic wave 312, which is transmitted to the predetermined object 350 through the radar correcting layer 340, the section 320, and the coating 330. Based on the predesigned distance between the radar transceiver 310 and the predetermined object 350, the time required for the transmitted electromagnetic wave to reach the predetermined object 350 may be simply calculated by, for example, the following equation:

$$t = \frac{d}{c} , \qquad ( 1 )$$

where t is the required time, d is the predesigned distance, and c is the velocity of the electromagnetic wave or the speed of light in the air.

The transmitted electromagnetic wave 312 is then reflected from the predetermined object 350, and the reflected electromagnetic wave or simply reflected signal 314 is returned to the radar transceiver 310. To reflect the electromagnetic wave 312, the predetermined object may include components which reflect all or substantially most of the transmitted electromagnetic wave 312 or may include a reflective coating on the outer surface. Further, the predetermined object 350 may be positioned along an orientation so that the reflected signal can be guided toward the radar transceiver 310.

Ideally, the time required for the reflected signal 314 to reach the radar transceiver should be equal to the time required for the transmitted electromagnetic wave to reach the predetermined object 350. Thus, the ideal total travel time from the radar transceiver 310 to the predetermined object 350 and from the predetermined object 350 back to the radar transceiver is two times the required time t, or 2t.

The radar transceiver 310 measures an actual total travel time from transmitting the electromagnetic wave 312 to receiving the reflected signal 314, and sends the actual total travel time to the computing device 360. In response to the reception, the computing device 360 calculates the difference between the actual total travel time and the ideal total travel time, and compares the difference with a travel time threshold. If the difference is greater than the travel time threshold, the computing device 360 may display an indication that the combination of the radar correcting layer 340 and the coating 330 does not meet the radar compliance requirement. The travel time threshold may be predetermined in consideration of the predesigned distance between the radar transceiver 310 and the predetermined object 350. In other words, when an operator of the computing device 360 enters the predesigned distance, the computing device 360 may automatically determine the travel time threshold.

Separately, the radar transceiver 310 may measure power and/or an amplitude of the reflected signal 314. The original power and/or amplitude of the electromagnetic wave 312 and the measured power and/or amplitude of the reflected signal 314 may be sent to the computing device 360. The difference between the original power and/or amplitude of the electromagnetic wave 312 and the measured power and/or amplitude of the reflected signal may be considered as a radar transmission loss. A radar transmission loss threshold may be compared with the radar transmission loss. The radar transmission loss threshold may also be predetermined based on the predesigned distance. When the radar transmission loss is less than the radar transmission loss threshold, the combination of the radar correcting layer 340 and the coating 330 is radar compliant. Otherwise, the combination may be determined to not be radar compliant.

Alternatively, a ratio between the original power and/or amplitude of the electromagnetic wave 312 and the measured power and/or amplitude of the reflected signal may be used. An ideal ratio between the original power and the ideally reflected power may be determined by the computing device 360 in consideration of the predesigned distance and a radar compliant coating. In this case, the ratio can be a representative value of radar transmission loss. A ratio threshold may be determined by the computing device 360 based on the predesigned distance. The computing device 360 then calculates a difference between the ideal ratio and the actual ratio, and compares the difference with the ratio threshold. When the difference is greater than the ratio threshold, the computing device 360 may inform the user that the combination of the radar correcting layer 340 and the coating 330 does not meet the radar compliance requirement. In other words, if the difference is less than or equal to the ratio threshold, the combination is radar compliant.

The computing device 360 may consider the total travel time and the ratio together with the predesigned distance and determine the radar compliance. Other environmental factors (e.g., temperature, moisture, etc.) and/or all parameters of the electromagnetic wave 312 and/or the reflected signal 314 may be also considered in determining the radar compliance.

Now turning to FIG. 3B, the computing device 360 is connected to the radar transceiver 310 and a radar receiver 370. Non-limiting examples of radar measurement devices that may be used in this environment includes the RMS-C or RMS-D Radome Measurement System available from Perisens GmbH, and the R&S QAR50 Automotive Radome Tester, available from Rohde & Schwarz GmbH. In the illustrated configuration, the electromagnetic wave 312, which is radiated by the radar transceiver 310, reaches the radar receiver 370, which does not reflect the electromagnetic wave 312 to the radar transceiver 310. Like the predetermined object 350 of FIG. 3A, the radar receiver 370 may be positioned at a predesigned distance from the radar transceiver 310.

When the electromagnetic wave 312 is radiated, the radar transceiver 310 may send the starting time of radiation of the electromagnetic wave 312 to the computing device 360. Alternatively, the computing device 360 may send a triggering control signal to the radar transceiver 310 so that the radar transceiver 310 is triggered to radiate the electromagnetic wave upon reception of the triggering control signal. In either case, the computing device 360 has the starting time of the radiation of the electromagnetic wave 312.

At the time when the electromagnetic wave 312 reaches the radar receiver 370, all measurements by the radar receiver 370 and the receiving time of the electromagnetic wave 312 are relayed to the computing device 360. The travel time, which is the difference between the receiving time and the starting time, is compared with the ideal one-way travel time, which is calculated according to the equation (1) above. The computing device 360, in this case, may use a half of the travel time threshold employed above when the both-way travel time is used, as a new threshold, in determining radar compliance. As described above, other factors, such as parameters of the electromagnetic waves 312 and environmental factors, may also be used in this configuration to determine radar compliance.

The combination of the configuration of FIG. 3A and the configuration of FIG. 3B may be used to determine radar compliance in both radiation and reflection directions of the electromagnetic wave 312. For example, the predetermined object 350 and the radar receiver 370 may be positioned in the direction of the electromagnetic wave transmission. Based on the measurements by the radar receiver 370, the computing device 360 can determine whether the combination of the coating 330 and the radar correcting layer 340 meets the radar compliance requirement in the forward direction.

Further, based on the measurements from both the radar receiver 370 and the radar transceiver 310, the computing device 360 can isolate the measurements in the reception of the reflected signal 314 from the measures in the radiation of the electromagnetic wave 312. Thus, based on the measurements in the reception or reflection direction to the radar transceiver 310, the computing device 360 can determine whether the combination of the coating 330 and the radar correcting layer 340 meets the radar compliance requirement in the reflection direction.

In a case when the radar compliance requirement is not met, the computing device may employ artificial intelligence or machine learning or other modeling and/or calculation methods to determine or provide recommendations about which type or thickness of the radar correcting layer 340 may better serve based on the measurement data under the circumstances. The computing device 360 may further provide whether the front or back of the section 320 may be better than the other for applying the radar correcting layer 340. The artificial intelligence or machine learning may be trained with training data set with appropriate labels.

After additionally applying a different or same radar correcting layer 340, the similar processes are performed to determine whether the combination of a new, different radar correcting layer 340 and the coating 330 is radar compliant. In this case, the new radar correcting layer may be different from or same as the previously applied radar correcting layer in size, thickness, and permittivity.

After one or more applications of one or more radar correcting layers 340 and determination that the combination meets the radar compliance requirement, temporarily applied one or more radar correcting layers 340 may be removed and one or more radar correcting layers, which have the same configuration as the temporarily applied radar correcting layers, are permanently applied to the section 320 of the vehicle. The computing device 360 may not be at the premise of the body shop but rather located in a remote place or in a cloud. Alternatively, the computing device 360 may not be a standalone computer but rather be a computational service provided by a cloud, such as Software as a Service (“SaaS”), Platform as a Service (“PaaS”), and Infrastructure as a Service (“IaaS”).

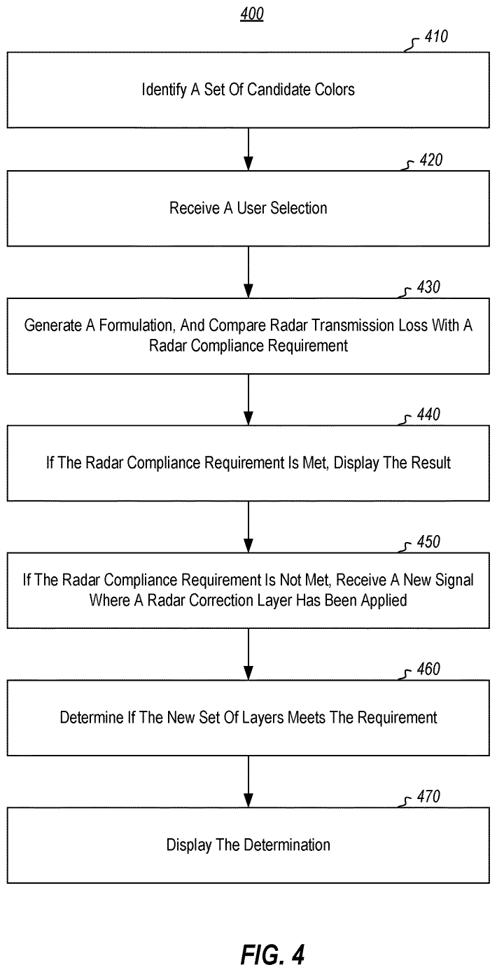

As described above, FIGS. 1A through 3B provide multiple components, modules, and schematics as part of a system for providing workflows at a body shop to ensure a new coating meets radar compliance requirement for a radar transceiver equipped for ADAS in a vehicle. The present disclosure can also be described in terms of one or more methods for accomplishing similar results. Along these lines, FIGS. 4-6 illustrate various methods for making a new coating radar complaint. The acts and steps illustrated in FIGS. 4-6 are discussed below with reference to the components and modules illustrated in FIGS. 1A-3B.

For example, FIG. 4 illustrates a method 400 of making a color match to be radar compliant when a new color coating corresponding to the color match is applied to a damaged portion of a vehicle. Method 400 may be practice manually or all or in part via a computer system implementing one or more storage media with computer-executable instructions for performing the given act or series of acts. Accordingly, FIG. 4 shows that method 400 can include act 410 of identifying a set of candidate colors from a database to match a color of a vehicle. The scanner 120 of FIG. 1A may be utilized in identifying a set of candidate colors by performing spectrophotometric measurements. The spectrophotometric database may also be used to identify a list of candidate colors, which are substantially close to the spectrophotometric measurements. Act 410 further includes displaying the set of candidate colors.

FIG. 4 further also shows that method 400 can include an act 420 of receiving a user selection. Act 420 can include receiving a user selection from a digital device of a candidate color from the set. For example, the end user 130 enters one of the displayed color selections shown on digital device 135, and a formulation engine (not shown) can then generate and/or mix the formula to be applied to vehicle 110. The digital device 135 may be the driver's or an operator's computing device at a body shop.

For example, FIG. 4 shows that method 400 can comprise an act 430 of generating a formulation, and comparing the radar transmission loss (if any) with a radar compliance requirement. Act 430 includes generating a formulation of the selected candidate color that is applied to the vehicle, and receiving a radar measurement pertaining to radar transmission loss due to the applied formulation, wherein the radar transmission loss is compared against a radar compliance requirement. For example, as noted above, the end-user refinishes the automobile with the user-selected coating, and may then take measurements to determine that the radar transmission through the vehicle and coating stack meets minimum radar loss compliance requirements. After application of the formulation, act 430 further includes receiving a radar measurement pertaining to radar transmission loss due to the applied formulation. The radar transceiver 210 of FIGS. 2A-2C or 310 of FIGS. 3A and 3B may generate measurement data, and the computing device 360 of FIGS. 3A and 3B may calculate the radar transmission loss based on the distance between the radar transceiver 310 and the predetermined object 350 or the radar receiver 370 of FIGS. 3A and 3B. The radar transmission loss is compared against a radar compliance requirement.

In addition, FIG. 4 shows that method 400 can comprise an act 440 of, if the radar compliance requirement is met, displaying the results. Act 440 can include if the radar transmission loss meets or exceeds the radar compliance requirement, displaying a result of the comparison. For example, the end user 130 can use a radar detector that is connected with the computer system 135, or otherwise obtain measurements from the transceiver 210 that provides a radar transmission loss. If the result is acceptable, the computer system 135 merely displays passage of the test. Act 440 considers a case where the radar transmission loss meets or exceeds the radar compliance requirement, and a result of the comparison is displayed in Act 440.

Furthermore, FIG. 4 shows that method 400 can comprise an act 450 of, if the radar compliance requirement is not met, receiving a new signal where a radar correction layer has been applied. Act 450 includes, if the radar transmission loss does not meet the radar compliance requirement, receiving a new measurement that represents a radar loss signal taken from a section of the vehicle where a radar correction layer has been applied, the section comprising the radar correcting layer at a location on the vehicle to which a radar transceiver radiates an electromagnetic wave. For example, FIGS. 2A through 2C show various iterations in which the end user 130 has positioned various radar correcting layers on the section 220 of the vehicle 110 where the radar transceiver is located. In general, the end user 130 can position the radar correcting layer 240/340 between the radar transceiver 210 and the vehicle section 220, or on top of another radar correcting layer 240/340 in the same section, or on the other/front side of the vehicle section (i.e., correcting layer 245, placed over coating stack 230). In act 450, a new measurement that represents a radar transmission loss from a section of the vehicle where a radar correcting layer has been applied is received. The section comprises the radar correcting layer at a location on the vehicle to which a radar transceiver 310 radiates an electromagnetic wave 312. The location may be front or back of the new coating with respect to the section of the vehicle body as shown in FIGS. 2A-2C. The radar transmission loss may be measured as a decrease in power or amplitude of the reflected signal from the original electromagnetic wave or as an increase in travel time from radiation of the electromagnetic wave to reception of the reflected signal.

Still further, FIG. 4 shows that method 400 can comprise an act 460 of determining if the new set of layers meets the requirement. Act 460 includes determining whether a combined set of layers comprising the radar correction layer, the section of the vehicle, and the applied formulation meets the radar compliance requirement. The determination of radar compliance may be done by comparing the radar loss with a threshold or radar compliance requirement.

Yet still further, FIG. 4 shows that method 400 can comprise an act 470 of displaying the determination. Act 470 includes displaying a result of the determination. For example, after the sufficiently oriented radar correcting layer (or layers) are properly positioned and the radar transmission loss of the combined stack of radar correcting layer, vehicle layer, and coating is deemed compliant, then the computer system 135 can display a successful result. In a case where the combined set of layers meets the radar compliance requirement, the combined set of layers may be removed because of its temporary nature and the same combined set of layers may be permanently applied at the same location where the temporary combined set of layers were previously applied. Alternatively, further fixation process can be performed on the temporarily applied set of layers so that the temporarily applied set of layers can be permanently affixed to the location without removing the combination.

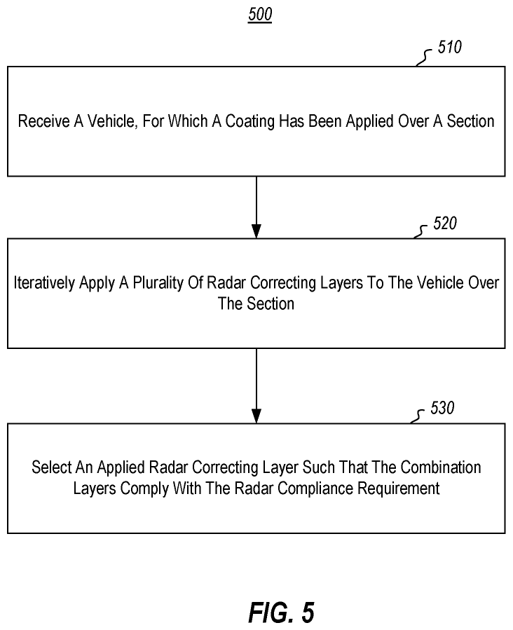

In addition to the foregoing, FIG. 5 shows that an additional or alternate method of making a new coating to be radar compliant can comprise a series of acts for accomplishing the same. Method 500 may be practice manually or all or in part via a computer system implementing one or more storage media with computer-executable instructions for performing the given act or series of acts. Accordingly, FIG. 5 shows that method 500 may include an act 510 of receiving a vehicle, for which a coating has been applied over a section to which a radar transceiver radiates an electromagnetic wave, where the coating does not comply with a radar compliance requirement. Act 510 includes iteratively applying a plurality of radar correcting layers to the vehicle over the section. For example, FIGS. 2A-2C show that one or more back-oriented radar correcting layers 240 (or backer layers) can be positioned between a radar transceiver and an inside surface of a vehicle section, i.e., section 220. In some cases, a single backer layer 240 will be applicable, while in other cases radar compliance may not be met unless a set of multiple backer layers stacked on top of each other achieve the appropriate result. In other cases, the end user may also or additionally apply one or more front-oriented radar correcting layers 245 on top of the coating of the vehicle. This may, again, be a single, or multiple layers, and may even be configured as an extra film coating placed over the enter section 220 of the vehicle, where the extra film serves the same purpose as the radar correcting layer due to its radar permittivity and thickness. Determination of the radar compliance can be based on measurements by the radar transceiver in the presence of the predetermined object 350 as illustrated in FIG. 3A or the radar receiver 370 as illustrated in FIG. 3B.

FIG. 5 also illustrates that method 500 can comprise an act 520 of iteratively applying a plurality of radar correcting layers. Act 520 includes iteratively applying a plurality of radar correcting layers to the vehicle over the section. For example, FIGS. 2A-2C show that one or more back-oriented radar correcting layers 240 (or backer layers) can be positioned between a radar transceiver and an inside surface of a vehicle section, i.e., section 220. In some cases, a single backer layer 240 will be applicable, while in other cases radar compliance may not be met unless a set of multiple backer layers stacked on top of each other achieve the appropriate result. In other cases, the end user may also or additionally apply one or more front-oriented radar correcting layers 245 on top of the coating of the vehicle. This may, again, be a single, or multiple layers, and may even be configured as an extra film coating placed over the enter section 220 of the vehicle, where the extra film serves the same purpose as the radar correcting layer due to its radar permittivity and thickness.

In addition, FIG. 5 shows that method 500 can comprise an act 530 of identifying when an applied radar correcting layer combined with the vehicle and its coating meet the radar compliance requirement. Act 530 can include selecting an applied radar correcting layer when the applied radar correcting layer changes a measured radar transmission loss through the section, such that the coating and radar correcting layer combine with the section of the vehicle to comply with the radar compliance requirement. For example, after each application of the one or more radar correcting layers 240/245, the user 130 can settle on the arrangement that minimized radar transmission loss in the combined stack of radar correcting layers 240/245, vehicle section 220, and applied coating 230. The plurality of radar correcting layers (e.g., 240a and 240b of FIG. 2C) may be applied one by one after removing the previously applied radar correcting layer or applied over the previously applied radar correcting layer. The iterative application process is performed until the application of one or more radar correcting layers makes the new coating radar compliant. In other words, the measured radar transmission loss is less than or equal to a threshold, and the combined layers are considered as meeting the radar compliance requirement. Upon confirmation of the radar compliance, the combined layers may be permanently affixed to the section of the vehicle.

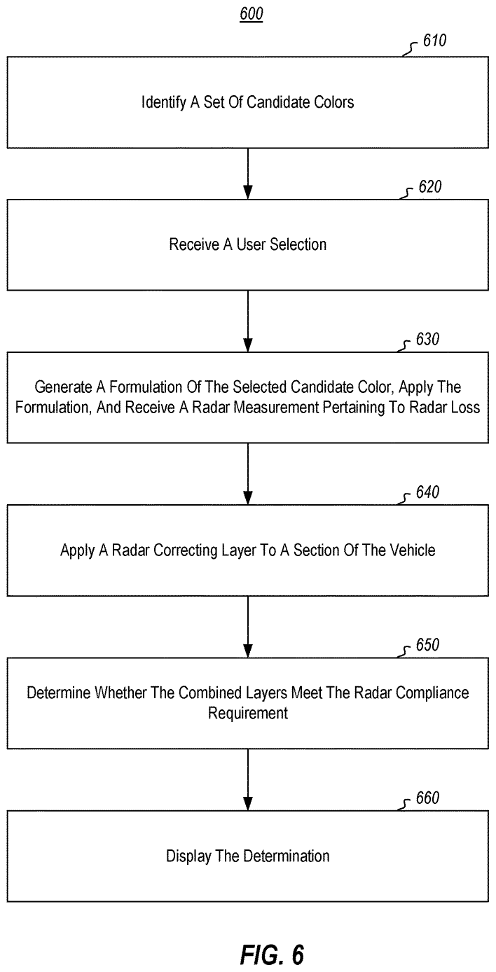

In addition to the foregoing, FIG. 6 illustrates that a method 600 of making a color coating to be radar compliant can comprise a series of one or more acts for accomplishing the same. Method 600 may be practiced manually or all or in part via a computer system implementing one or more storage media with computer-executable instructions for performing the given act or series of acts. Accordingly, FIG. 6 shows that the method of FIG. 6 includes act 610 of identifying a set of candidate colors from database to match a color of a vehicle. As described for the method 400, the scanner 120 of FIG. 1A may be used to perform spectrophotometric measurements to identify the set of candidate colors. Act 610 further includes displaying the set of candidate colors.

In addition, FIG. 6 shows that the method 600 can comprise an act 620 of receiving a user selection of a candidate color from the set. The selection can be made through an action on a display of a computing device.

Further, FIG. 6 shows that the method 600 can comprise an act 630 of generating a formulation of the selected candidate color, applying the formulation to at least a portion of the vehicle, and receiving a radar measurement pertaining to radar loss due to the applied formulation. The radar transceiver 210 of FIGS. 2A-2C or 310 of FIGS. 3A and 3B may generate measurement data, and the computing device 360 of FIGS. 3A and 3B may calculate the radar transmission loss based on the distance between the radar transceiver 310 and the predetermined object 350 or the radar receiver 370 of FIGS. 3A and 3B. The radar transmission loss is compared against a radar compliance requirement or the transmission loss threshold.

In a case where the radar transmission loss is greater than the transmission loss threshold or does not meet the radar compliance requirement, FIG. 6 shows that the method can comprise an act 640 of applying a radar correcting layer to a section of the vehicle to which a radar transceiver radiates an electromagnetic wave. As illustrated in FIG. 1B, the end-user 130 can apply the radar correcting layer 150. Also as illustrated in FIGS. 2A-2C, the radar correcting layer may be applied in the back or in the front of the new coating with respect to the section of the vehicle.

Furthermore, FIG. 6 shows that the method 600 can comprise an act 650 of determining whether the radar correcting layer combined with the section of the vehicle and applied formulation meets the radar compliance requirement.

Still further, FIG. 6 shows that the method 600 can comprise an act 660 of displaying a result of the determination. Based on the determination, acts 640-660 may be iteratively performed until the radar correcting layer combined with the section of the vehicle and applied formulation meets the radar compliance requirement.

One will appreciate, therefore, in view of the present specification and claims that the present disclosure can be practiced in a wide range of environments, including a range and type of radar correcting layers to make a new coating radar compliant. One will further appreciate that the present disclosure can be implemented in a wide range of settings. For example, in addition to the automotive-style asset repair analyses described herein, the present disclosure can be applied to defect analysis and repair employed in a wide range of assets, including heavy industrial and light industrial vehicles, as well as personal vehicles. The radar correcting layers 150 disclosed herein can also be added, measured, and removed in a variety of refinish, or OEM assembly contexts. For example, in some cases it may be helpful to remove the given part (e.g., a bumper fascia), and place the bumper fascia in a location as outlined in FIGS. 3A-3B with an emitter and detector on opposing sides, and then iteratively applying various of the one or more radar correcting layers until the radar specification (i.e., acceptably low radar transmission loss) and therefore radar compliance is achieved. In other cases, this can be accomplished by applying the radar correcting layer to the vehicle section (e.g., the bumper fascia) without removing it.

Still further, while the present disclosure can be practiced with the use of a computer system (135, 360, etc.) for purposes of assistance in measuring and displaying radar transmission results, or other predictive functions (e.g., number/arrangement of layers 150), the present disclosure can also be practiced entirely manually in some cases. For example, without the assistance of computer recommendations, a basic environment may involve the use of a portable or non-portable radar emitter and radar detector positioned at fixed points about a vehicle section. The user can then iteratively apply given radar correcting layers 150 until identifying the radar correcting layer configuration that provides an acceptably-low amount of radar transmission loss. Accordingly, the present disclosure can be practiced in both simplified and complex environments, depending on the type of machinery available to the end-user 130, thus enabling the disclosure to be adopted widely.

In particular, the present disclosure can be practiced with respect to more traditional facilities in the form of roofed buildings, such as vehicle body shops. The present disclosure (in particular principles of artificial intelligence) can further be used to identify a particular color, or even quality of a color match, such as may be used in automotive and residential coating matches. Still further, the present disclosure can be used in suggesting potential radar correcting layers to make the new coating radar compliant. One will appreciate therefore that principles of the present disclosure can be applied not just to identifying of potential candidate colors, but also to measuring radar transmission loss and confirming radar compliance of applied one or more radar correcting layers with the new coating.

The present disclosure may comprise or utilize a special-purpose or general-purpose computer system that includes computer hardware, such as, for example, one or more processors and system memory, as discussed in greater detail below. The scope of the present disclosure also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general purpose- or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the disclosure may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

In view of the foregoing, the present disclosure may be embodied in multiple different configurations, and additional or alternative configurations thereof. For example, at least one configuration may include a computer-implemented method of minimizing radar loss by virtue of an applied coating, comprising: iteratively applying one or more radar correcting layers to a vehicle, for which a coating has been applied over a section to which a radar transceiver radiates an electromagnetic wave, wherein the coating and vehicle section, in combination, do not comply with a radar compliance requirement; and selecting a radar correcting layer of the one or more radar correcting layers that, when the selected radar correcting layer is applied over the section, changes a measured radar transmission loss through the section, such that the coating and the selected radar correcting layer combine with the section of the vehicle to comply with the radar compliance requirement. In additional or alternative configurations, the computer-implemented method can further include removing the section of the vehicle, and positioning a radar emitter and a radar receiver on opposing sides of the section; and measuring changes in the measured radar transmission loss with each application of additional radar correcting layers.

In additional or alternative configurations, the computer-implemented method can further include identifying a set of candidate colors from a database to match a color of the vehicle, and displaying the set of candidate colors; receiving a user selection from a digital device of a candidate color from the set; generating a formulation of the selected candidate color that is applied to the vehicle, and receiving a radar measurement pertaining to radar transmission loss due to the applied formulation on the vehicle, wherein the radar transmission loss is compared against the radar compliance requirement; wherein: (i) if the radar transmission loss meets or exceeds the radar compliance requirement, displaying a result of the comparison, or (ii) if the radar transmission loss does not meet the radar compliance requirement, receiving a new measurement that represents a radar loss signal taken from a section of the vehicle where a radar correction layer has been applied, the section comprising the radar correcting layer at a location on the vehicle to which a radar transceiver radiates an electromagnetic wave; determining whether a combined set of layers comprising the selected radar correction layer, the section of the vehicle, and the applied formulation meets the radar compliance requirement; and displaying a result of the determination.

In additional or alternative configurations, the computer-implemented method can further include displaying an indication if any of the candidate formulations is not optimized for radar compliance. In additional or alternative configurations, the selected radar correcting layer comprises a plurality of radar correcting layers attached to one or both of an inner surface of the vehicle section and/or an outer surface of the vehicle section In additional or alternative configurations, when the radar transmission loss does not meet the radar compliance requirement, the method further comprises: receiving a new radar measurement corresponding to application of a different radar correcting layer; and determining whether the different radar correcting layer combined with the applied formulation and vehicle section meets the radar compliance requirement, wherein the determination indicates a transmittance of the electromagnetic wave through the different radar correcting layer, the vehicle section, and the applied formulation. In additional or alternative configurations, receiving a new radar measurement further comprises: receiving a plurality of different radar measurements; wherein: each radar measurement of the plurality corresponds to a different radar correcting layer of a different thickness that has been added to the applied formulation and vehicle section.

In additional or alternative configurations, receiving a new radar measurement further comprises: receiving a plurality of different radar measurements; wherein: each different radar measurement corresponds to a different layering of two or more radar correcting layers. In additional or alternative configurations, wherein at least one radar correcting layer further differs from another radar correcting layer at least by permittivity. In additional or alternative configurations, at least one radar correcting layer further differs from another radar correcting layer in permittivity by at least a value of 1.0. In additional or alternative configurations, at least one radar correcting layer has a permittivity value of at least 4; and another radar correcting layer has a permittivity value within a range of from 2.0 to 3.0. In additional or alternative configurations, the computer-implemented method can further include selecting one or multiple radar correcting layers among iteratively applied radar correcting layers based on measured transmission loss. In additional or alternative configurations, the computer-implemented method can further include permanently applying the one or multiple radar correcting layer(s) over the section. In additional or alternative configurations, the radar measurement is taken from a section of the vehicle that has been isolated with a radar emitter and a radar receiver on opposing sides thereof.

In additional or alternative configurations, the radar correcting layer is a film or wrap. In additional or alternative configurations, the radar correcting layer is applied between the applied generated coating and the radar transceiver. In additional or alternative configurations, the radar correcting layer is applied to an outer surface of the applied generated coating. In additional or alternative configurations, the candidate colors are based on a spectrophotometric measurement of the vehicle. In additional or alternative configurations, wherein the candidate colors are based on a vehicle identification number (VIN), a make/model, or manufacturer paint code.

In addition to the foregoing, an additional or alternative configuration of the disclosure can include a computer-implemented method of minimizing radar loss by virtue of an applied coating, which can include: receiving a vehicle, for which a coating has been applied over a section to which a radar transceiver radiates an electromagnetic wave, wherein the coated section does not comply with a radar compliance requirement; iteratively applying a plurality of radar correcting layers to the vehicle over the coated section; and selecting an applied radar correcting layer when the applied radar correcting layer changes a measured radar transmission loss through the coated section, such that the coating and radar correcting layer combine with the coated section of the vehicle to comply with the radar compliance requirement In additional or alternative configurations, multiple radar correcting layers are applied over another to create a combination layer, and the combination layer combined with the applied coating renders the coating, the vehicle section, and the combination layer to comply with the radar compliance requirement.

In additional or alternative configurations, each radar correcting layer is applied as a replacement of a previously applied radar correcting layer, and each applied radar correcting layer is measured in combination with the applied coating and the coated section of the vehicle for radar compliance. In additional or alternative configurations, each of iteratively applied radar correcting layers is a backer layer intended for positioning on an inside surface of the coated section of the vehicle and in front of the radar transceiver. In additional or alternative configurations, each of iteratively applied radar correcting layers is a front layer intended for positioning on an outside surface of the vehicle and in front of the radar transceiver. In additional or alternative configurations, each of the radar correcting layers has a thickness that differs from another radar correcting layer. In additional or alternative configurations, at least one of the radar correcting layers comprises a film or wrap. In additional or alternative configurations, the applied coating includes a base coat and a clearcoat. In additional or alternative configurations, the radar measurement is taken from a section of the vehicle with a radar emitter and a radar receiver positioned on opposing sides thereof.

Furthermore, still another additional or alternative configuration of the present disclosure can include a system having a memory, a processor, and one or more non-transitory computer readable medium including one or more programs stored thereon that, when executed by a computer, cause the computer to perform the following: identify a set of candidate colors from a database to match a color of a vehicle, and displaying the set of candidate colors; receive a user selection from a digital device of a candidate color from the set; generate a formulation of the selected candidate color that is applied to the vehicle, and receiving a radar measurement pertaining to radar transmission loss due to the applied formulation, wherein the radar transmission loss is compared against a radar compliance requirement; and wherein: (i) if the radar transmission loss meets or exceeds the radar compliance requirement, display a result of the comparison, or (ii) if the radar transmission loss does not meet the radar compliance requirement, receive a new measurement that represents a radar loss signal taken from a section of the vehicle where a radar correction layer has been applied, the section comprising the radar correcting layer at a location on the vehicle to which a radar transceiver radiates an electromagnetic wave; determine whether a combined set of layers comprising the radar correction layer, the section of the vehicle, and the applied formulation meets the radar compliance requirement; and display a result of the determination.

Yet still further, another additional or alternative configuration of the present disclosure can include a method of minimizing radar loss by virtue of an applied coating, which further includes iteratively applying, by a user, one or more radar correcting layer to a section of a vehicle, for which a coating has been applied over the section, and to which a radar transceiver radiates an electromagnetic wave, wherein the combination of applied coating and section of the vehicle, a does not comply with a radar compliance requirement; and after application of each iteratively applied radar correcting layer determining whether the applied radar correcting layers change a measured radar transmission loss through the section, such that the coating, and the selected radar correcting layers combine with the section of the vehicle to comply with the radar compliance requirement.

Furthermore, another additional or alternative configuration of the present disclosure can include a method of minimizing radar loss by virtue of an applied coating, which includes: determining that a vehicle section and an applied coating do not meet a radar compliance requirement when transmitting an electromagnetic wave through the vehicle section; applying an initial radar correcting layer to the vehicle section; and determining that a measured radar transmission loss changes when the initial radar correcting layer is applied over the section. In additional or alternative configurations, a measured radar transmission loss of the combination of coating, initial radar correcting layer, and section of the vehicle complies with the radar compliance requirement. In additional or alternative configurations, applying the radar correcting layer further comprises: determining that the measured radar transmission loss remains out of compliance with the radar compliance requirement; iteratively applying one or more additional radar correcting layers to the vehicle section; determining for each applied additional radar correcting layers a new measurement of radar transmission loss over the vehicle section; and completing application of the one or more additional radar correcting layers upon determining that the vehicle section with all applied radar correcting layers meets the radar compliance requirement.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

1. A computer-implemented method of minimizing radar loss by virtue of an applied coating, comprising:
iteratively applying one or more radar correcting layers to a vehicle, for which a coating has been applied over a section to which a radar transceiver radiates an electromagnetic wave, wherein the coating and vehicle section, in combination, do not comply with a radar compliance requirement; and
selecting a radar correcting layer of the one or more radar correcting layers that, when the selected radar correcting layer is applied over the section, changes a measured radar transmission loss through the section, such that the coating and the selected radar correcting layer combine with the section of the vehicle to comply with the radar compliance requirement.

2. The computer-implemented method of claim 1, further comprising:
removing the section of the vehicle, and positioning a radar emitter and a radar receiver on opposing sides of the section; and
measuring changes in the measured radar transmission loss with each application of additional radar correcting layers.

3. The computer-implemented method of claim 1, further comprising:
identifying a set of candidate colors from a database to match a color of the vehicle, and displaying the set of candidate colors;
receiving a user selection from a digital device of a candidate color from the set;
generating a formulation of the selected candidate color that is applied to the vehicle, and receiving a radar measurement pertaining to radar transmission loss due to the applied formulation on the vehicle, wherein the radar transmission loss is compared against the radar compliance requirement;
wherein:
(i) if the radar transmission loss meets or exceeds the radar compliance requirement, displaying a result of the comparison, or
(ii) if the radar transmission loss does not meet the radar compliance requirement, receiving a new measurement that represents a radar loss signal taken from a section of the vehicle where a radar correction layer has been applied, the section comprising the radar correcting layer at a location on the vehicle to which a radar transceiver radiates an electromagnetic wave;
determining whether a combined set of layers comprising the selected radar correction layer, the section of the vehicle, and the applied formulation meets the radar compliance requirement; and
displaying a result of the determination.

4. (canceled)

5. The computer-implemented method of claim 3, wherein, the selected radar correcting layer comprises a plurality of radar correcting layers attached to one or both of an inner surface of the vehicle section and/or an outer surface of the vehicle section.

6. The computer-implemented method according to claim 3, wherein, when the radar transmission loss does not meet the radar compliance requirement, the method further comprises:
receiving a new radar measurement corresponding to application of a different radar correcting layer, wherein receiving a new radar measurement further comprises receiving a plurality of different radar measurements;
wherein each radar measurement of the plurality corresponds to a different radar correcting layer of a different thickness that has been added to the applied formulation and vehicle section; and.
each different radar measurement corresponds to a different layering of two or more radar correcting layers; and
determining whether the different radar correcting layer combined with the applied formulation and vehicle section meets the radar compliance requirement, wherein the determination indicates a transmittance of the electromagnetic wave through the different radar correcting layer, the vehicle section, and the applied formulation;
selecting one or multiple radar correcting layers among iteratively applied radar correcting layers based on measured transmission loss; and
permanently applying the one or multiple radar correcting layer(s) over the section.

7. (canceled)

8. (canceled)

9. The computer-implemented method according to claim 6, wherein at least one radar correcting layer further differs from another radar correcting layer at least by permittivity.

10. The computer-implemented method according to claim 6, wherein at least one radar correcting layer further differs from another radar correcting layer in permittivity by at least a value of 1.0.

11. The computer-implemented method according to claim 6, wherein:
at least one radar correcting layer has a permittivity value of at least 4; and
another radar correcting layer has a permittivity value within a range of from 2.0 to 3.0.

12. (canceled)

13. (canceled)

14. The computer-implemented method according to claim 3, wherein the radar measurement is taken from a section of the vehicle that has been isolated with a radar emitter and a radar receiver on opposing sides thereof.

15. The computer-implemented method according to claim 3, wherein the radar correcting layer is a film or wrap.

16. (canceled)

17. (canceled)

18. The computer-implemented method according to claim 3, wherein the candidate colors are based on a spectrophotometric measurement of the vehicle.

19. The computer-implemented method according to claim 3, wherein the candidate colors are based on a vehicle identification number (VIN), a make/model, or manufacturer paint code.

20. A computer-implemented method of minimizing radar loss by virtue of an applied coating, comprising:
receiving a vehicle, for which a coating has been applied over a section to which a radar transceiver radiates an electromagnetic wave, wherein the coated section does not comply with a radar compliance requirement;
iteratively applying a plurality of radar correcting layers to the vehicle over the coated section; and
selecting an applied radar correcting layer when the applied radar correcting layer changes a measured radar transmission loss through the coated section, such that the coating and radar correcting layer combine with the coated section of the vehicle to comply with the radar compliance requirement.

21. The computer-implemented method according to claim 20, wherein:
multiple radar correcting layers are applied over another to create a combination layer, and
the combination layer combined with the applied coating renders the coating, the vehicle section, and the combination layer to comply with the radar compliance requirement.

22. The computer-implemented method according to claim 20, wherein:
each radar correcting layer is applied as a replacement of a previously applied radar correcting layer, and
each applied radar correcting layer is measured in combination with the applied coating and the coated section of the vehicle for radar compliance.

23. The computer-implemented method according to claim 20, wherein each of iteratively applied radar correcting layers is a backer layer intended for positioning on an inside surface of the coated section of the vehicle and in front of the radar transceiver.

24. The computer-implemented method according to claim 20, wherein each of iteratively applied radar correcting layers is a front layer intended for positioning on an outside surface of the vehicle and in front of the radar transceiver.

25. The computer-implemented method according to claim 20, wherein each of the radar correcting layers has a thickness that differs from another radar correcting layer.

26. The computer-implemented method according to claim 20, wherein:
at least one of the radar correcting layers comprises a film or wrap; and the applied coating includes a base coat and a clearcoat.

27. (canceled)

28. (canceled)

29. (canceled)

30. (canceled)

31. A method of minimizing radar loss by virtue of an applied coating, comprising:
determining that a vehicle section and an applied coating do not meet a radar compliance requirement when transmitting an electromagnetic wave through the vehicle section;
applying an initial radar correcting layer to the vehicle section; and
determining that a measured radar transmission loss changes when the initial radar correcting layer is applied over the section;
wherein applying the radar correcting layer further comprises:
determining that the measured radar transmission loss remains out of compliance with the radar compliance requirement;
iteratively applying one or more additional radar correcting layers to the vehicle section;
determining for each applied additional radar correcting layers a new measurement of radar transmission loss over the vehicle section; and
completing application of the one or more additional radar correcting layers upon determining that the vehicle section with all applied radar correcting layers meets the radar compliance requirement.

32. (canceled)

33. (canceled)
